(19) United States
(12) Patent Application Publication
(10) Pub. No.: US 2006/0107507 A1
(43) Pub. Date: May 25, 2006

(54) Method and device for the positionally precise mounting of a hinged flap on a part

(75) Inventors: Volker Brose, Stuttgart (DE); Helmut Kraus, Hildrizhausen (DE); Enrico Philipp, Stuttgart (DE); Michael Riestenpatt Genannt Richter, Bondorf (DE); Bernd Schuler, Haiterbach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler A G, Stuttgart (DE)

(21) Appl. No.: 10/527,723

(22) PCT Filed: Sep. 6, 2003
(86) PCT No.: PCT/EP03/09921

§ 371 Date: Sep. 9, 2005

(30) Foreign Application Priority Data
Sep. 13, 2002 (DE) 102 42 710.0

(51) Int. Cl. B23Q 17/00; B23P 21/00

(52) U.S. Cl. 29/407.1; 29/407.05; 29/407.09; 29/705

(57) ABSTRACT

A method for mounting a flap (3) on a workpiece (1) in a precisely positioned fashion, in particular for mounting a vehicle door on a vehicle body. A robot guided gripping tool (5) has a securing device (14) for holding the flap (3) and a sensor system (18) permanently connected to the gripping tool (5). In a first step, the gripping tool (5) is moved, within the scope of a positioning phase (A-2), from a proximity position (37), which is independent of the position of the workpiece (1) in the working space (27) of the robot (7), into a mounting position (29) in which the flap (3) which is held in the securing device (14) is oriented with respect to the workpiece (1) in a precisely positioned fashion. To move into the mounting position (29), an iterative closed-loop control process is run through, in the course of which firstly an (actual) measured value of the sensor system (18) is generated, which value is compared with a (setpoint) measured value which is generated within the scope of a setup phase. A movement vector of the gripping tool (5) is calculated from the difference between the (actual) measured value and (setpoint) measured value using a Jacobi matrix calculated within the scope of the setup phase, and the gripping tool (5) is moved by an amount equal to this movement vector. The flap (3) is then attached to the workpiece (1) using attachment elements (9).

The invention relates to a method for mounting a flap on a workpiece, wherein the flap is positioned precisely with respect to a reference area on the workpiece, according to the preamble of patent claim 1, as disclosed, for example, in EP 470 939 A1. Furthermore, the invention relates to a device for carrying out this method.

Flaps are fastened to vehicle bodies at different locations in the external area and in the internal area in the course of the mounting operation. The term “flap” is intended here to designate quite generally a pivotable add-on part which is attached to another component, in the present case the body, by means of a hinge, a joint or the like. Examples of such flaps in motor vehicle engineering are driver's doors and rear doors, engine hoods, trunk lids, fuel tank covers etc. In the interest of a high-quality appearance of the vehicle body it is necessary to orient these flaps with respect to adjacent areas on the vehicle body or other (adjacent) add-on parts and installed parts with a high degree of accuracy, and thus position them in such a way that a predefined junction between the flap and the adjoining areas of the vehicle body is ensured. For this purpose, the flap must be oriented in a precisely positioned fashion with respect to the vehicle body and be attached to the vehicle body in this state using the connection elements (hinges, joints, screws, etc.).

Thus, for example the driver's door and the rear door have to be fitted into the door opening in the vehicle body in such a way that gap dimensions, junctions and depth dimensions for the adjacent areas of the vehicle body, in particular the A pillar and/or C pillar, the B pillar and the roof area are obtained which have the highest possible degree of allround uniformity. Each of these two doors is attached to the vehicle body by means of two hinges. In order therefore to ensure a high-accuracy orientation of the driver's door and of the rear door with respect to the adjacent vehicle body areas, the doors must firstly be fitted into the respective door opening in an optimum position and then connected to hinges in this position.

EP 470 939 A1 proposes a mounting method with which positionally accurate orientation and attachment of a vehicle door in the door opening of a vehicle body is to be achieved. In this context, a robot-guided gripping tool which removes the door to be inserted from a load carrier and inserts it into the door opening is used. In the method in EP 407 939 A1 the unequipped gripping tool is firstly moved into a (spatially fixed) reference position with respect to the door opening, in which reference position images of the door opening of the vehicle body are taken using cameras which are permanently mounted on the gripping tool, and the position of the door opening relative to the reference position of the gripping tool is calculated from this (first) set of images. A door is then removed from the load carrier by means of the gripping tool and the equipped gripping tool is moved again into the reference position in which a further (second) set of images is taken by means of the camera mounted on the gripping tool, and the position of the door which is held in the gripping tool is calculated from said images. By comparing the sets of image data a movement vector expressing the amount by which the gripping tool is to be moved is determined in order to bring about the desired orientation of the door with respect to the door opening. The gripping tool is offset by an amount equal to this movement vector, and in the relative position which is now assumed by the gripping tool with respect to the door opening the hinges which are provided on the door are connected to the vehicle body (using welding robots).

The method which is known from EP 470 939 Al proceeds from two sets of image data of the door opening or of the door which are both taken in a (spatially fixed) reference position of the gripping tool. The method is thus based on sensing the absolute positions of the vehicle body and of the door relative to the reference position in the working space of the robot to whose arm the gripping tool is attached. For the successful application of this method, a plurality of peripheral conditions must be fulfilled:
at first each camera which is used for determining position must be capable of determining individual measured values metrically with respect to their internal reference coordinate system (“internal metric calibration of the cameras”).
furthermore, the position of the cameras in the working space of the gripping tool robot must be known (“external metric calibration of the cameras”).
finally, the individual measurements of the cameras must be combined and compressed in such a way that the accurate position of the door opening or of the door with respect to the working space of the robot can be calculated in a consistent and reliable fashion in terms of processing.

In order to calibrate the sensors, EP 470 939 A1 provides a calibration device (not described in more detail) which has to be approached in each cycle of the robot. However, it has been found empirically here that a large amount of setting up and calibration work is required for the camera and for the entire system in order to fulfill the abovementioned peripheral conditions, and this work can only be carried out by experts. Furthermore, a high level of precision and reproducibility of the measured values can only be achieved using high-quality (and therefore expensive) sensors.

The further problem of the method proposed in EP 470 939 A1 is that the process of acquiring image data for the vehicle body door opening on the one hand, and the process acquiring image data for the door, on the other, are carried out in different, chronologically offset processing steps. Even slight movements in the vehicle body during the positioning process therefore lead to large faults and need to be prevented.

The invention is therefore based on the object of proposing a method for mounting a flap on a workpiece, in particular on a vehicle body, in a precisely positioned fashion, which method is associated with a significantly reduced amount of work for calibration and which permits, even when cost-effective sensors are used, the accuracy to be improved compared to conventional methods. The invention is also based on the object of proposing a device which is suitable for carrying out the method.

The object is achieved according to the invention by means of the features of claims 1 and 8.

In order to position and attach the flap to the vehicle body, a robot-guided gripping tool is used which comprises a securing device for the flap and a sensor system which is permanently connected to the gripping tool. The securing device of the gripping tool is equipped with a flap and is firstly placed, under control by a robot, in a proximity position(for which there is permanent programming and which is independent of the current position of the vehicle body in the working space of the robot) with respect to the vehicle body. The gripping tool is then moved by means of a closed-loop control process to a mounting position in which the flap which is held in the securing device is oriented in a precisely positioned fashion in the desired “optimum” installation position with respect to the adjacent areas on the vehicle body. In this closed-loop control process, in which the gripping tool is moved from the proximity position into the mounting position, (actual) measured values from selected reference areas on the vehicle body and on the flap are generated by the sensor system; these (actual) measured values are compared with (setpoint) measured values which have been generated in a preceding setup phase. The gripping tool is then moved by an amount equal to a movement vector (comprising linear movements and/or rotations), which vector is calculated from the difference between the (actual) and (setpoint) measured values using what is referred to as a “Jacobi matrix” (or “sensitivity matrix”). Both the (setpoint) measured values and the Jacobi matrix are determined within the scope of a setup phase which occurs before the actual positioning and mounting process, within the scope of which setup phase the gripping tool is trained to the specific mounting task. This setup phase is run through once in the course of the setting up of a new combination of tool, sensor system, type of vehicle body and type and installation position of the flap to be used.

Once the closed-loop control process described above has been completed and the flap which is held in the gripping tool is thus in the desired mounting position with respect to the vehicle body, the next method step starts, in the course of which the flap is mounted on the vehicle body. During this step, the predefined mounting program is run through under the control of a robot, and other robot-guided tools (for example welding robots, screwing robots, feed devices for attachment elements . . . ) are also involved apart from the gripping tool. The essential fact here is that during the processing of the mounting program the mounting position which is discovered in the course of the positioning process and is arranged in a precisely positioned fashion with respect to the vehicle body is used as a reference position for all the further tools and working steps involved in the mounting process.

The positioning process which is run through in a closed-loop controlled fashion and in the scope of which the flap which is held in the gripping tool is moved from the proximity position (moved into under control by a robot) into the mounting position (oriented in a precisely positioned fashion with respect to the vehicle body), differs basically from the positioning process which is known from EP 470 939 A1: in the method in EP 470 939 A1 the absolute position of the vehicle body (or of the door opening) in the working space of the robot is firstly in fact determined in the course of the positioning process and then forms the basis for the orientation of the equipped gripping tool. In contrast to this, the method according to the invention is based on relative measurements, within the scope of which information (stored in the setup phase) is restored by means of the closed-loop control process, said information corresponding to a set of (setpoint) measured values of the sensor system.

This leads to two essential simplifications compared to the prior art:
on the one hand internal metric calibration of the sensors is no longer necessary since the sensors which are used no longer “measure” but merely react to a monotonous incremental movement of the robot with a monotonous change in its sensor signal. This means, for example, that when a television camera or CCD camera is used as a sensor the camera-internal lens designations no longer have to be compensated and that when a triangulation sensor is used the accurate metric calculation of distance values is eliminated.
Furthermore, external metric calibration of the sensors is no longer necessary: in contrast to the prior art the position of the sensors has no longer to be determined metrically with respect to the working space of the robot or the coordinate system of the robot's hand in order to be able to calculate suitable correction movements. The sensors merely have to be attached to the gripping tool in such a way that they are at all capable of sensing suitable measurement data of the reference areas on the vehicle body and the flap in their capture region.

When the method according to the invention is used it is thus possible to dispense completely with the metric measurement function which can generally be determined only at high cost and the calibration device which is shown in EP 470 939 A1. It is therefore possible to use metrically uncalibrated sensors which are significantly simpler and thus also cheaper than calibrated sensors. Both the design of the instrumentation and the setup and the operation of the entire system can therefore be implemented very cost-effectively when the method according to the invention is used. Furthermore, when the method according to the invention is used the initial setup and maintenance of the mounting system are drastically simplified and can also be carried out by trained personnel.

The result of the positioning of the flap with respect to the vehicle body is also independent of the absolute positioning accuracy of the robot used since possible robot inaccuracies are compensated during the movement into the mounting position. Owing to the resulting short fault chains, it is possible, when necessary, to achieve a very high repetition accuracy in the positioning result. Robot positioning inaccuracies owing to temperature fluctuations, incorrect calibration of the robot etc. are compensated.

The number of degrees of freedom of positioning which can be compensated with the method according to the invention in the positioning phase is freely selectable and depends on the configuration of the sensor system. The number of sensors used can also be freely selected. The number of (scalar) sensor information items made available must merely be equal to or greater than the number of degrees of freedom to be regulated. In particular, a relatively large number of sensors can be provided and the redundant sensor information can be used in order, for example, to be able to sense better shaping errors in the vehicle body area under consideration and/or the flap to be fitted in or to improve the positioning process in terms of its accuracy. Finally, sensor information can be used from different contact-free and/or tactile sources (for example a combination of CCD cameras, optical gap sensors and tactile distance sensors). As a result, by using suitable sensors, the measurement results of different quality-related variables (gap dimensions, junction dimensions, depth dimensions) can be taken into account during the process of fitting in the flap.

The method according to the invention can very easily be adapted to new problems since only the acquisition and conditioning of the sensor data, but not the closed-loop controlling system core, has to be adapted. It is possible to dispense, during the positioning process, with the use of modem knowledge about the vehicle body and the flap to be inserted.

In comparison with the method in EP 470 939 A1, the invention permits a significantly faster compensation of residual uncertainties which may occur when positioning the flap with respect to the opening in the vehicle body; such residual uncertainties may, about due to positional errors of the vehicle body in the operating area of the robot which are caused by conveying equipment, as a result of positional deviations of the flap in the gripping tool and/or as a result of shaping errors of the flap to be inserted or of the vehicle body which are caused by component tolerances. Owing to this rapid position control of the gripping tool with respect to the vehicle body, the vehicle body does not need to be clamped in a stationary fashion during the positioning process but rather can be moved with respect to the robot (for example on an assembly line or some other suitable conveying equipment). This permits a high degree of flexibility of the method according to the invention which can thus be applied to very different application cases of the mounting of flaps to stationary and moving workpieces.

The closed-loop controlled movement into the mounting position may be carried out in a single control loop, but in this context an iterative method is preferably used in which threshold values are predefined as abort criteria: as a result the iteration process is aborted if the deviation between the (setpoint) measured value and the (actual) measured value lies below a predefined threshold value; furthermore, the iteration process is aborted if the reduction in the deviation between the (setpoint) measured value and (actual) measured value which is to be brought about during successive iteration steps lies below a further predefined threshold value.

The attachment elements (hinges, joints, . . . ) by means of which the flap is connected to the vehicle body can be part of the flap to be mounted so that these attachment elements only have to be connected to the workpiece in this mounting position after the above-described positioning of the flap in the opening in the vehicle body has ended. However, in many cases hinges which are firstly attached to the vehicle body before the flap is coupled to the hinges are used for connecting flaps to vehicle bodies. In this case it is advantageous to carry out the mounting of the hinges on the vehicle body in the same working step as the mounting of the flap. In this case, the mounting method advantageously comprises the following process steps:

A the gripping tool is equipped with a flap which is to be installed and is moved, in accordance with the iterative closed-loop control process described above, from the proximity position (moved into in an open-loop controlled fashion) into the mounting position with respect to the vehicle body, in which mounting position the flap is oriented with respect to the opening in the vehicle body in a positionally accurate fashion;

B the gripping tool is moved, under the control of a robot, from the mounting position by the permanently predefined offset into an avoidance position in order to provide space for a robot-controlled hinge mounting system in the mounting area;

C the hinge mounting system, for example a screw tool which is equipped with hinges, attaches the hinges, under the control of a robot, in a predefined attachment region of the vehicle body and then withdraws from the working area;

D the gripping tool is moved, under the control of a robot, by the permanently predefined offset out of the avoidance position back into the mounting position (and the flap is thus re-positioned precisely in the mounting area);

E the flap is attached to the hinges using a robot-controlled mounting tool (for example a screwdriver which is attached to the gripping tool);

F the gripping tool is moved, under the control of a robot, into a return position in which, without the risk of a collision of the gripping tool with the vehicle body, the vehicle body is removed from the working area of the robot and a new vehicle body can be fed in.

The process step B corresponds here to an “exporting” of the flap, which is reversed in the process step D. The essential fact here is that the process steps B, D and E are carried out under the control of a robot as relative movements to the mounting position which has been discovered in process step A, with the result that the mounting position which has been discovered in the closed-loop control process of the process step A is used as a reference position for the further tools which are involved in these process steps.

In order to achieve a particularly high level of accuracy, it is advantageous also to associate the mounting of the hinges (process step C) with the mounting position discovered in process step A as a reference position. In this case, the mounting of the hinges (process step C) comprises the following working steps:

C-1 the hinge mounting system is equipped with hinges and is moved in an iterative closed-loop control process, analogous to the closed-loop control process described above for fitting in the flap, into a working position with respect to the gripping tool, in which working position the hinge mounting system is oriented in a precisely positioned fashion with respect to the face on the door where the hinge is to be screwed on or with respect to an auxiliary face on the gripping tool (located in the avoidance position); this closed-loop control process ties the hinge mounting system to the mounting position of the flap (found in process A);

C-2 starting from the working position, the hinge mounting system runs through, under the control of a robot, a predefined processing program during which the hinges are attached to the opening in the vehicle body using, for example, screwdrivers of the hinge mounting system;

C-3 the hinge mounting system is moved under the control of a robot out of the processing area so that the gripping tool with the flap can be moved back into the mounting position without the risk of collision.

In the method sequence described here all the method steps, with the exception of steps A and C-1, take place under the control of a robot, i.e. by executing predefined processing programs and/or shifting of the paths of the robots and tools which are involved. The steps A and C-1 correspond to iterative closed-loop control processes in the course of which the flap which is to be used is positioned in the opening in the vehicle body in a precisely positioned fashion (step A) and/or the hinge mounting system is oriented with respect to the flap or the gripping tool (step C-1).

Further advantageous embodiments of the invention can be found in the subclaims. The invention is explained in more detail below with reference to an exemplary embodiment which is illustrated in the drawings, in which:

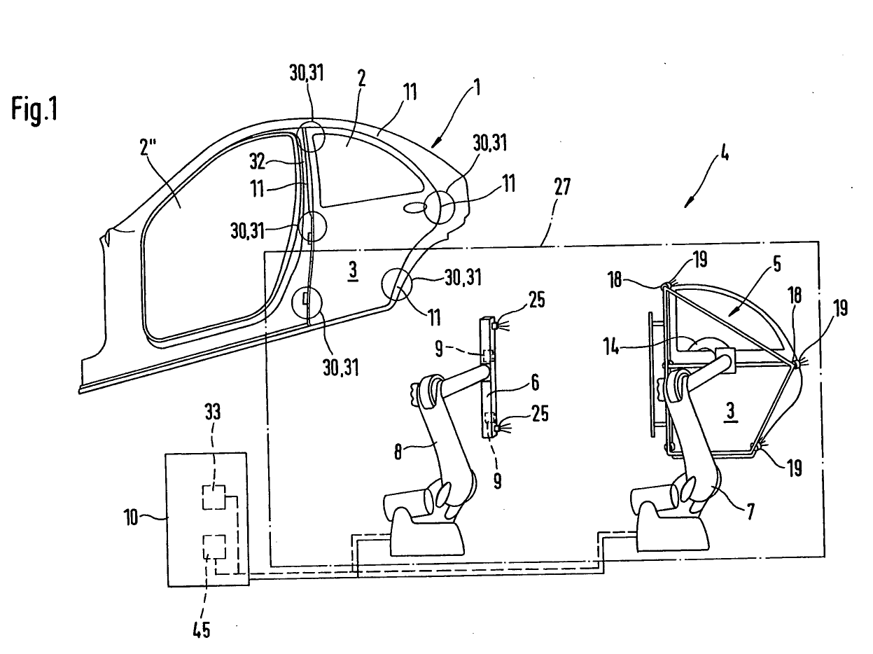

FIG. 1 shows a schematic view of a vehicle body with a mounting system for installing a rear door;

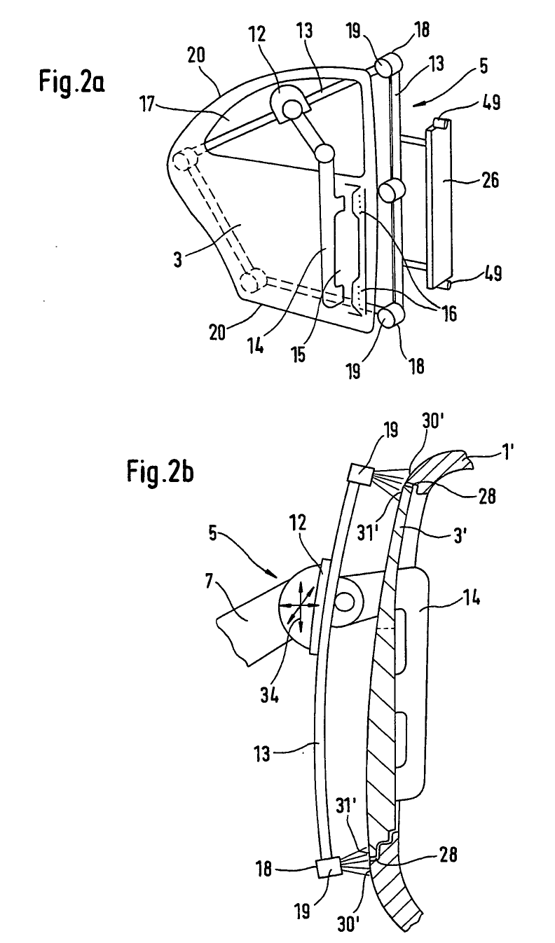

FIG. 2a shows a schematic plan view of the rear door which is held in a gripping tool;

FIG. 2b shows a schematic sectional view of the rear door which is held in a mounting position with respect to the vehicle body using the gripping tool;

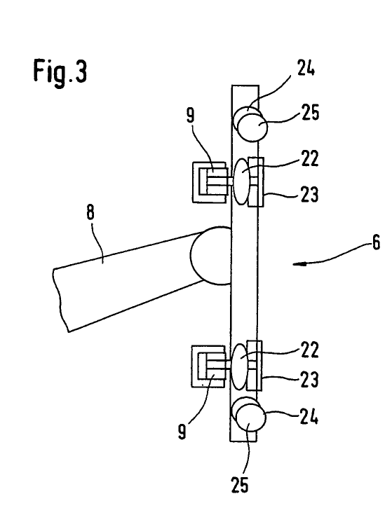

FIG. 3 shows a schematic plan view of a hinge mounting tool with the hinges held therein;

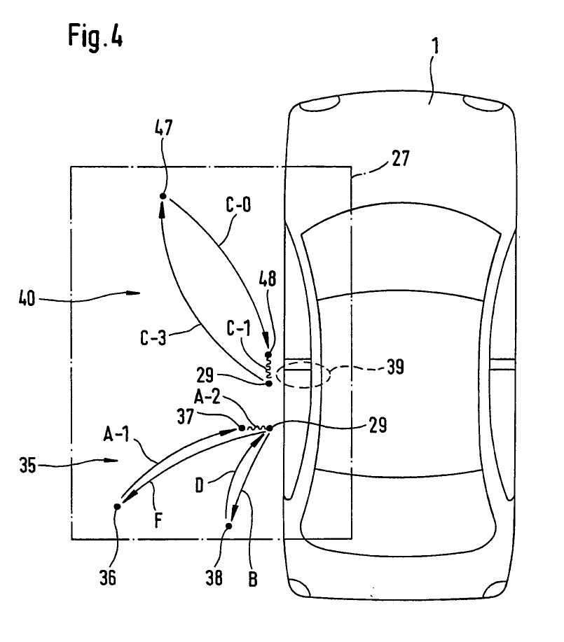

FIG. 4 shows a schematic representation of the movement paths of the robot hands which are fitted with the gripping tool and the hinge mounting tool, during execution of the mounting of the door;

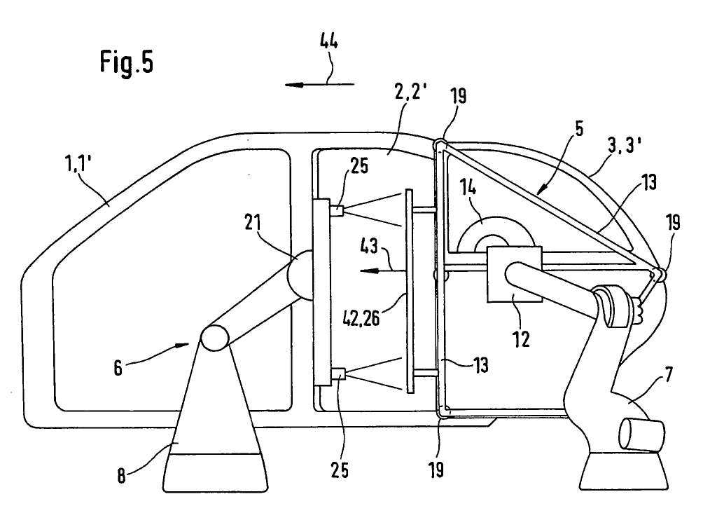

FIG. 5 shows a schematic view of a vehicle body with the gripping tool located in the avoidance position, and the hinge mounting tool located in the working position.

FIG. 1 shows a detail of a vehicle body 1 with a rear door opening 2 into which a rear door 3 is inserted, and a front door opening 2″ into which a driver's door (not illustrated in FIG. 1) is to be mounted. This vehicle body 1 is an example of a workpiece 1 with an opening 2 into which a pivottable flap 3 (whose shape is adapted to the opening) is to be inserted.

The rear door 3 is mounted in the vehicle body 1 using an automatic mounting system 4 (illustrated schematically in FIG. 1) with a working space 27. The mounting system 4 comprises a gripping tool 5 which is guided by an industrial robot 7 and which feeds the rear door 3 and positions it precisely with respect to the vehicle body 1. Furthermore, the mounting system 4 comprises a hinge mounting system 6 which is guided by an industrial robot 8 and which feeds hinges to the vehicle body 1, orients them with respect to the vehicle body 1 and the precisely positioned door and attaches them to a hinge joining area 39 in the door opening 2. A control system 10 is provided for controlling the position and movement of the robots 7, 8 and thus of the tools 5, 6.

By analogy to the mounting system 4 in FIG. 1 for mounting the left-hand rear door 3, a further mounting system (on the opposite side of the vehicle body 1) is provided for the right-hand rear door, the design and method of operation of which correspond to the mounting system 4 (mirror-inverted). The driver's doors are mounted using correspondingly adapted mounting systems, analogously to the mounting of the rear door.

In order to mount the rear door 3 in the door opening 2, the hinges 9 are firstly attached in the hinge joining areas 39 of the door opening 2, and the rear door 3 is then fastened to the hinges 9 in the defined position. The position in which the hinges 9 are attached in the door opening 2 determines the position of the completely-mounted rear door 3 in the door opening 2 in a decisive way here. In order to ensure a high-quality visual impression of the vehicle body 1, the rear door 3 must be mounted in a precisely positioned fashion (in terms of position and angular attitude) with respect to the areas 11 of the vehicle body 1 which are adjacent to the door opening 2; the surrounding areas 11 thus form what is referred to as a reference area for the orientation of the rear door 3 with respect to the vehicle body 1.

The gripping tool 5 which is used for positioning the rear door 3 in the door opening 2 and the subsequent mounting is shown schematically in FIG. 2a. This gripping tool which is attached to the hand of the industrial robot 7 comprises a frame 13 to which a securing device 14 is attached and which can be used to hold the rear door 3 in a well defined position. The rear door 3 is advantageously held by the securing device 14 on the inside 15 of the rear door 3 in the direct proximity of the hinge holding faces 16 to which the attachment hinges 9 are screwed in the course of the mounting of the door. This selection of the engagement points of the securing device 14 on the rear door 3 ensures that the distortion of the shape which occurs during the installation of the door is minimal. Setting phenomena of the door 3 are thus taken into account. This ensures that the securing device 14 is configured in such a way that the area of the hinge holding faces 16 on the inside 15 of the door is freely accessible so that the hinges 9 can be mounted while the door 3 is located n the securing device 14. The configuration of the securing device 14 which is shown in FIG. 2a also ensures that the door 3 can be positioned by the gripping tool 5 in the installation position (i.e. in the closed state) on the vehicle body 1. The securing device 14 is arranged so as to be rotatable and/or pivotable with respect to the frame 13 of the gripping tool 5 so that after the mounting it can be removed through the window opening 17 of the mounted and closed door 3. Alternatively, the door 3 can also be gripped on the outer skin.

In order to measure the position and orient the rear door 3 which is secured in the gripping tool 5 with respect to the vehicle body 1 the gripping tool 5 is provided with a sensor system 18 with a plurality or sensors 19 (five in the schematic illustration in FIG. 2a) which are rigidly connected to the frame 13 of the gripping tool 5; they thus form one structural unit with the gripping tool 5. These sensors 19 are used to determine joint dimensions, gap dimensions and depth dimensions between the peripheral regions 20 of the rear door 3 and the adjacent areas 11 of the door opening 2 on the vehicle body 1. Using this sensor system 18, the rear door 3 which is held in the gripping tool 5 is oriented, as described below, in an iterative closed-loop control process with respect to the door opening 2 of the vehicle body 1.

The hinge mounting system 6 is attached to the hand 21 of the second industrial robot 8 and comprises two hinge tension jacks 22 in which the two hinges 9, which are necessary for attaching the door 3 in the door opening 3, are held in a defined precisely positioned and precisely angled orientation (see FIG. 3). Furthermore, the hinge mounting system 6 comprises robot-controlled dynamometric screwdrivers (not shown in FIG. 3) for attaching the hinges 9 in the door opening 2 in the vehicle body 1. The hinge tension jacks 22 are configured in such a way, and arranged with respect to the screwdrivers, in such a way that the screwing faces 23 at which the hinges 9 are connected to the vehicle body 1 are accessible to the screwdrivers. The hinges 9 are inserted (automatically or manually) into the receptacles 22, with the possibility of the attachment screws (not shown in FIG. 3) with which the hinges 9 are attached to the vehicle body 1 being inserted or supplied later automatically, together with the hinges 9.

The hinge mounting system 6 is also provided with a sensor system 24 which comprises a plurality of sensors 25 (2 in the schematic illustration in FIG. 3) which form one structural unit with the hinge mounting system 6. These sensors 25 are used, as described later, for positioning the hinge mounting system 6 with respect to the gripper tool 5.

If the mounting system 4 is to be set to a new processing task—for example to mounting the rear door in a new type of vehicle or to mounting the driver's door, at first it is necessary to run through what is referred to as a setup phase in which the gripping tool 5 and the hinge mounting system 6 are configured. In this context, a securing device 14 which is adapted to the door 3 to be mounted, a suitably shaped frame 13 and the sensor system 18 with the corresponding sensors 19 are selected and configured together to form a gripping tool 5. The sensor system 18 of the gripping tool 5 is then “trained” by recording (setpoint) measured values of the sensor system 18 on a “master” vehicle body 1′ and a “master” door 3′ and programming the path sections of the movement path of the robot 7 to be run through in an open-loop controlled fashion, as described below in section I. Furthermore, the hinge mounting system 6 is configured in accordance with the mounting task, provided with sensors 25 and “trained” by recording (setpoint) measured values of the sensors 25 in a reference area 26 of the gripping tool 5 for this tool also and programming the path sections of the movement path of the robot 8 to be run through in an open-loop controlled fashion, as described below in section II. After this setup phase has ended, the mounting system 4 which is configured and calibrated in this way is then ready for use in series production, during which what is referred to as a working phase is run through for each vehicle body 1 which is supplied to the working space 27 of the robots 7, 8 and in which, as described below in section III, an associated door 3 is positioned and attached to the door opening 2.

I. Setup Phase of the Gripping Tool 5:

In order to carry out a newly set mounting task, in a first step a sensor system 18 which is adapted to the mounting task is firstly selected for the gripping tool 5 and attached together with the securing device 14 to the frame 13. The gripping tool 5 which is assembled in this way is attached to the robot's hand 12. The securing device 14 is then equipped with a (“master”) rear door 3′ and oriented (manually or interactively) with respect to a (“master”) vehicle body 1′ in the working space 27 of the robot 7 in such a way that an “optimum” orientation of the (“master”) rear door 3′ with respect to the (“master”) vehicle body 1′ is brought about (see FIG. 2b). Such an “optimum” orientation may be defined, for example, by a gap 28 between the (“master”) rear door 3′ and (“master”) vehicle body 1′ being as uniform as possible or by the gap 28 assuming specific values in specific regions. The relative position which is assumed here by the gripping tool 5 with respect to the (“master”) vehicle body 1′ is referred to below as mounting position 29.

The number and position of the sensors 19 on the frame 13 is selected in such a way that the sensors 19 are directed towards suitable areas 30′ which are particularly important for the “optimum” orientation, on the (“master”) vehicle body 1′ or areas 31′ of the (“master”) rear door 3′. In the exemplary embodiment in FIG. 2a, five sensors 19 are used which are directed towards the areas 30, 31 shown in FIG. 1, so that three sensors 19 are directed towards the gap 28 in the region of the B pillar 32, while the two other sensors 19) carry out gap measurements in the rear region of the rear door 3. It has been found empirically that these regions 30, 31 are particularly important for the position and orientation of the rear door 3 in the door opening 2. The number of individual sensors 19 and the surroundings 30, 31 towards which they are directed are evaluated in such a way that they permit the best possible characterization of the quality features which are relevant for the respective application case. In addition to the gap for measurement sensors 19, for the sensors which measure, for example, a (depth) distance and/or the junction between vehicle body 1 and rear door 3, can also be provided.

The gripping tool 5 with the sensor system 18 and with the (“master”) rear door 3′ which is held in the securing device 14 is then “trained” using the robot 7 to the mounting position 29 (set by means of the manual or interactive orientation and assumed in the illustration in FIG. 2b) with respect to the (“master”) vehicle body 1′. In this context, measured values of all the sensors 19 are firstly recorded in the mounting position 29 and stored as “setpoint measured values” in an evaluation unit 33 of the sensor system 18; this sensor evaluation unit 33 is expediently integrated into the control system 10. The position of the gripping tool 5 and of the (“master”) rear door 3′, secured therein, with respect to the (“master”) vehicle body 1′ is then changed systematically, starting from the mounting position 29, along known movement paths, as indicated in FIG. 2b by arrows 34, using the robots 7; these are generally incremental movements of the robot 7 in its degrees of freedom. The changes in the measured values of the sensors 19 which occur in this context are recorded (completely or partially). What is referred to as a “Jacobi” matrix (sensitivity matrix) is calculated from this sensor information in a known fashion, said matrix describing the relationship between the incremental movements of the robot 7 and the changes in the sensor measured values which occur in the process. The method for determining the Jacobi matrix is described, for example, in “A tutorial on visual servo control” by S. Hutchinson, G. Hager and P. Corke, IEEE Transactions on Robotics and Automation 12(5), October 1996, pages 651-670. This article also describes the requirements made of the movement paths or the measuring environment (constancy, monotony, . . . ) which have to be fulfilled in order to obtain a valid Jacobi matrix. The incremental movements are selected in such a way that collisions between the gripping tools 5 or the (“master”) rear door 3′ and the (“master”) vehicle body 1′ cannot occur during this setup process.

The Jacobi matrix which is generated in the setup phase is stored in the evaluation unit 33 of the sensor system 18 together with the “setpoint measured values” and they form the basis for the later positioning closed-loop control process A-2 in the working phase (see III in below).

Furthermore, in the setup phase a movement path 35 of the robot's hand 12 (and thus also of the gripping tool 5) is generated and is run through in a controlled fashion in the later working phase III. This movement path 35 is illustrated schematically in FIG. 4. The starting point of the movement path 35 is formed by what is referred to as a “return movement position” 36 which is selected in such a way that a new vehicle body 1 can be introduced into the working space 27 of the robot 7 without the risk of collisions between the vehicle body 1 and the gripping tool 5 or the rear door 3 held in it. This return movement position 36 may correspond, for example, to an equipping station (not illustrated in figures) in which the gripping tool 5 is equipped (manually) with a rear door 3 which is to be constructed. The return movement position 36 can alternatively correspond to a removal station in which a rear door 3 which is to be constructed is removed from a load carrier by the gripping tool 5. Starting from this return movement position 36, the movement path 35 comprises the following separate sections:

A-1 the gripping tool 5 with inserted (“master”) rear door 3′ is moved from the return movement position 36 on a path A-1, which is to be run through in an open-loop controlled fashion, into what is referred to as an open-loop “proximity position” 37 which is selected such that all the individual sensors 19 of the sensor system 18 can sense valid measured values of the respective area 30, 31 of the (“master”) rear door 3′ and/or of the (“master”) vehicle body 1′ while at the same time ensuring that collisions cannot occur between the gripping tool 5 or the rear door 3 and the vehicle body 1.

A-2 The gripping tool 5 with inserted (“master”) rear door 3′ is moved on a path A-2, to be run through in a closed-loop controlled fashion, from the proximity position 37 into the mounting position 29 (which has been “trained” as described above) in which the (“master”) rear door 3′ which is held in the gripping tool 5 is oriented in a precisely positioned and precisely angled fashion with respect to the door opening 2′ in the (“master”) vehicle body 1′. The particular events during this process step which is to be run through in a closed-loop controlled fashion are described below (in III working phase).

B The gripping tool 5 with inserted (“master”) rear door 3′ is moved on a path B which is to be run through in an open-loop controlled fashion from the mounting position 29 into an avoidance position 38 in which the (“master”) rear door 3′ does not adversely affect the joining region 39 of the hinges 9 in the door opening 2′. The gripping tool 5 therefore makes a defined avoiding movement in order to provide space for the installation of the hinges 9.

D The gripping tool 5 with inserted (“master”) rear door 3′ is transported back on a path D to be run through in a controlled fashion from the avoidance position 39 into the mounting position 29 (which has been “trained” as described above) in which the (“master”) rear door 3′ which is held in the gripping tool 5 is oriented in a precisely positioned and precisely angled fashion with respect to the door opening 2′ in the (“master”) vehicle body 1′. This path D may be in particular the “reverse” of the path B.

F The gripping tool 5 is moved back under the control of a robot into the return movement position 36.

The movement path 35, generated within the scope of the setup phase, of the gripping tool 5 is thus composed of four sections A-1, B, D and F which are to be run through in an open-loop controlled fashion, and one section A-2 which is to be run through in a closed-loop controlled fashion. The steps A-1, B, D and F can be input interactively during the training phase of the gripping tool 5 or they can be stored in the form of a CNC program (generated off line) in the control system 10.

II. Setup Phase of the Hinge Mounting System 6:

In a subsequent step, the movement path 40 of the hinge mounting system 6 (provided with a plurality of sensors 25 and attached to the robot's hand 21 of the hinge robot 21) is trained:

In a way which is analogous to the training of the mounting position 29 of the gripping tool 5 which was described above, what is referred to as the “working position” 41 of the hinge mounting system 6 is firstly trained here. For this purpose, the gripping tool 5 is positioned in the avoidance position 28 (end position of the path section V) with respect to the (“master”) vehicle body 1′. The hinge mounting system 6 is then equipped with the two hinges 9 and oriented (manually or interactively) with respect to the door opening 2′ of the (“master”) vehicle body 1′ in such a way that the hinges 9 in the joining area 39 of the door opening 2′ are positioned in an “optimum” orientation and attachment position. The relative position which is assumed here by the hinge mounting system 6 with respect to the (“master”) vehicle body 1′ is referred to below as “working position” 41 of the hinge mounting system 6.

The sensors 25 are attached to the hinge mounting system 6 in such a way that they are directed toward a selected reference area 26 on the gripping tool 5, toward an auxiliary face 42 on the gripping tool 5 in the present exemplary embodiment. In the present case, the “auxiliary face” 42 is a planar face whose surface normal 43 extends approximately parallel to the longitudinal direction 44 of the vehicle when the gripping tool 5 is located in the avoidance position 38 (illustrated in FIG. 5). The sensors 25 are (optical) distance measuring sensors which measure the distance from the auxiliary face 42 (for example using the triangulation principle). By evaluating the measured values of the sensors it is possible to determine the distance between the hinge mounting system 6 and the auxiliary face 42 in the longitudinal direction 44 of the vehicle; furthermore, the angular position of the hinge mounting system 6 with respect to the auxiliary face 42 (and thus with respect to the avoidance position 38 of the gripping tool 5) can be calculated.

The hinge mounting system 6 having the sensors 25 is then “trained” to the working position 41 (set manually or interactively) with respect to the auxiliary face 42 of the gripping tool 5 using the hinge robot 8. This iterative training is carried out in a way analogous to the process of training the gripping tool 5 described in section I, during which process the gripping tool 5 was trained into the mounting position 29 with respect to the (“master”) vehicle body 1′. Firstly, while the hinge mounting system 6 is located in the working position 41, measured values of the auxiliary face 42 are recorded using the sensors 25 and stored as “setpoint measured values” in an evaluation unit 45 which is associated with the sensor system 24 and which is integrated into the open-loop control system 10. The position of the hinge mounting system 6 with respect to the auxiliary face 42 of the gripping tool 5 is then changed systematically along known movement paths starting from this working position 41 using the robot 8. From the changes in the measured values of the sensors 25 which are associated with this, the Jacobi matrix (sensitivity matrix) of the hinge mounting system 6 is calculated, said matrix describing the relationship between the incremental movements of the hinge robot 8 and the changes in the measured values of the sensors 25 which occur in the process. The incremental movements are selected in such a way that collisions cannot occur between the hinge mounting system 6 and the (“master”) vehicle body 1′ during this setup process.

The Jacobi matrix which is generated is stored, together with the “setpoint measured values” in the evaluation unit 45 of the sensor system 24 and forms the basis for the later closed-loop control process in the positioning phase of the hinge mounting system 6 (see below in section C-1).

In addition to training the working position 41, a movement path 46 of the hinge robot's hand 21 is generated in the setup phase of the hinge mounting system 6, said movement path 46 being represented together with the movement path 35 of the robot's hand 12 of the gripping tool 5 in FIG. 4 in a schematic fashion. The starting point of the movement path 46 of the hinge mounting system 6 is formed by what is referred to as a “hinge holding position” 47 which is selected in such a way that a new vehicle body 1 can be introduced into the working space 27 of the robot 8 without collisions being able to occur between the vehicle body 1 and the hinge mounting system 6. In this hinge holding position 47, the hinge tension jacks 22 can be equipped (manually or automatically) with hinges 9 which are to be installed. Starting from this hinge holding position 47 the movement path 46 of the hinge mounting system 6 comprises the following separate sections:

C-0 the hinge mounting system 6 with inserted hinges 9 is moved, on a path C-0 which is to be run through in an open-loop controlled fashion, from the hinge holding position 47 into what is referred to as a proximity position 48 which is selected in such a way that the sensors 25 supply the valid measured values of the auxiliary face 42 of the gripping tool 5 (in the avoidance position 38).

C-1 the hinge mounting system 6 with inserted hinges 9 is moved, on a path C-I to be run through in a closed-loop controlled fashion, from the proximity position 48 into the working position 48 (which has been “trained” as described above) in which the hinge mounting system 6 is oriented in a precisely angled fashion and at a precise distance with respect to the auxiliary face 42 of the gripping tool 5.

C-3 the hinge mounting system 6 is moved back into the hinge holding position 47 under the control of a robot.

The movement path 46, generated within the scope of this setup phase, of the hinge holding system 6 is thus composed of two sections C-0 and C-3 which are to be run through in an open-loop controlled fashion, as well as a section C-1 which is to be run through in a closed-loop controlled fashion.

III. Working Phase

In the working phase, vehicle bodies 1 are sequentially supplied to the working space 27 of the mounting system 4 and clamped in, and the movement paths 35, 46 which are generated in the setup phases are run through by the gripping tool 5 and the hinge mounting system 6 for each vehicle body 1.

Movement Path Section A-1:

While the new vehicle body 1 is being fed in, the gripping tool 5 is in the return movement position 36 and is equipped with a rear door 3 to be mounted; the hinge mounting system 6 is located in the hinge holding position 47 in which the hinge tension jacks 22 are equipped with hinges 9. As soon the new vehicle body 1 has been moved into the working space 27 and secured there, the gripping tool 5 with inserted rear door 3 is moved into the proximity position 37 in a controlled fashion.

Movement Path Section A-2 (Positioning Phase of the Gripping Tool 5):

Starting from the proximity phase 37, a positioning phase of the tool (path section A-2 in FIG. 4) is run through, in the scope of which phase the rear door 3 which is held in the gripping tool 5 is moved into the mounting position 29 (trained during the training phase) with respect to the vehicle body 1 and in the process is oriented in a positionally precise fashion with respect to the door opening 2 in the vehicle body 1. For this purpose, the sensors 19 of the sensor system 18 record measured values in the selected areas 30, 31 of the rear door 3 and of the vehicle body 1. These measured values and the Jacobi matrix determined in the setup phase are used to calculate a movement increment (movement vector) which reduces the difference between the current (actual) sensor measured values and the (setpoint) sensor measured values. The rear door 3 which is held in the gripping tool 5 is then moved and/or pivoted by this movement increment using the robot 7 and new (actual) sensor measured values are recorded during the ongoing movement.

This iterative measurement and movement process is repeated in the control loop until the difference between the current (actual) and the aimed-at (setpoint) sensor measured values drops below a predefined fault measure, or until this difference no longer changes beyond a threshold value which is specified in advance. The rear door 3 is then located (within the scope of the accuracy predefined by the fault measure or threshold value) in the mounting position 29 (illustrated in FIG. 3) with respect to the vehicle body 1.

The iterative minimization which is run through in this positioning phase A-2 compensates both inaccuracies in the vehicle body 1 with respect to its position and orientation in the working space 27 of the robot 7 and possibly present shape faults in the vehicle body 1 (i.e. deviations from the (“master”) vehicle body 1′). At the same time, inaccuracies in the rear door 3 with respect to its position and orientation in the gripping tool 5 and possibly present shape faults of the rear door 3 are compensated (i.e. deviations from the (“master”) rear door 3′). The rear door 3 is therefore fitted into the door opening 2 in the vehicle body 1 in the course of this iterative closed-loop control process in the “optimum” way, independently of shape and position inaccuracies. In order to detect and evaluate shape faults of the rear door 3 and of the vehicle body 1 separately it is possible to provide additional sensors on the gripping tool 5, the measured values of which sensors are used exclusively or partially for sensing the shape faults. Furthermore, the measured values of the individual sensors 19 can be provided with different weighting factors in order to bring about a weighted position optimization of the rear door 3 with respect to the door opening 2 in the vehicle body 1.

The movement of the position and changing of the angle—which have taken place within the scope of the closed-loop control process of this positioning phase A-2—of the rear door 3 which is held in the gripping tool 5 (corresponding to the movement between the proximity sensor 37 and the mounting position 29) can be passed on to the control system 10 of the robot 7 in the form of what is referred to as a zero point correction. The control system 10 of the robot 7 thus “knows” the starting position (corresponding to the mounting position 29) which corresponds to the optimum fitting of the rear door 3 into the door opening 2. An important property of this positioning phase is its independence of the accuracy of the robot: since the positioning process is based on an iterative comparison of the (actual) measured values with (setpoint) measured values, any inaccuracy in the position of the robot 7 is compensated immediately by the iterative closed-loop control process.

Movement path sections B and C-0 (avoidance phase of the gripping tool 5 and preparation of the hinge mounting system 6):

Starting from the mounting position 29, the gripping tool 5 with the rear door 3 held in it is then transported into the avoidance position 38 under the control of the robot 7. In this way, space for the hinge mounting system 6 which is equipped with hinges 9 and which is moved into the proximity position 48 in an open-loop controlled fashion subsequent to, or at the same time as, the avoidance phase B of the gripping tool 5, is provided in the joining area 39 of the door opening 2.

Movement Path Section C-1 (Positioning Phase of the Hinge Mounting System 6):

Starting from the proximity position 48, the hinge mounting system 6 is then moved into the working position 41 (trained during the training phase) with respect to the gripping tool 5 which is located in the avoidance position 38. This positioning phase proceeds in an analogous way to the positioning phase of the section A-2 in the course of which the gripping tool 5 was positioned with respect to the vehicle body 1: the sensors 25 of the hinge mounting system 6 are used to record measured values of the auxiliary face 42 on the gripping tool 5, and a movement increment is calculated from these measured values using the Jacobi matrix which is determined in the setup phase, in order to move the hinge mounting system 6 using the robot 8. This measurement and movement process is repeated iteratively until the difference between the current (actual) and the aimed-at (setpoint) sensor measured values drops below a predefined fault measure, or until this difference no longer changes beyond a threshold value specified in advance. The hinge mounting system 6 is then in the working position 41 (illustrated in FIG. 5) with respect to the gripping tool 5 and with respect to the vehicle body 1. The spatial position of the robot's hand 21 which corresponds to the working position 41 is stored in the control system 10. Sensors 49 on the auxiliary face 42 measure the position of the hinges 9 and also store the result of a setpoint data set in the control system 10.

Since the hinge mounting system 6 is oriented with respect to the gripping tool 5 by means of distance measurements in relation to the planar face 42 which is oriented approximately perpendicularly with respect to the longitudinal direction 44 of the vehicle, this process step permits the hinge mounting tool 6 to be positioned in the longitudinal direction 44 of the vehicle, but not perpendicularly to it. The movement of the hinge mounting tool 6 in the transverse direction of the vehicle is carried out in an open-loop controlled fashion in this case (in contrast to the movement in the longitudinal direction of the vehicle which is carried out in a closed-loop controlled fashion) so that the hinge mounting system 6 is moved in an open-loop controlled fashion to the joining area 39 in the door opening 2 perpendicularly to the direction 44 of the vehicle, and the hinges 9 are pressed onto the joining area 39 using springs or a suitable pneumatic system.

Operation C-2 (Attachment of the Hinges 9 in the Door Opening 2)

The hinges 9 are then mounted in the door opening 2 in the working position 41 of the hinge mounting system 6 in which the hinges 9 are positioned and pressed against the desired location in the joining area 39 of the door opening 2. For example screwdrivers which are provided on the hinge mounting system 6 (but are not shown in the figures) can be used for this and can engage on the attachment screws of the hinges 9 for this operation. Alternatively, it is possible to use other screwdrivers which are attached to additional robots or handling systems.

After the hinges 9 are mounted, the hinge tension jacks 22 are opened and the hinges 9 released. The sensors 49 on the auxiliary face 42 are used to measure the position of the screwed-on hinges 9 and compare it with the hinge position (stored as a setpoint data set in the control computer 10) in the unscrewed state. In the case of deviations, the hinges 9 are secured once more in the hinge tension jacks 22 and moved by the measured offset under the control of a robot. This process is repeated until the position of the screwed hinges 9 correspond to the position of the unscrewed hinges. In this way, the elastic and plastic influences of the screwing process can be compensated and particularly high positional accuracy of the hinges 9 in the joining area 39 can be achieved.

When the hinges are attached in the desired (setpoint) position in the joining area 39 of the door opening 2, the hinge tension jacks 22 and the hinges 9 are released.

Movement path sections C-3 and D (return movement of the hinge mounting system 6 and approaching movement of the gripping tool 5):

The hinge mounting system 6 (without the hinges 9) is then firstly moved back out of the working position 41 into the hinge holding position 47 under the control of the robot. As a result, the space around the joining area 39 becomes clear again and the gripping tool 5 with the rear door 3 can be moved back after the avoidance position 38 into the mounting position 29 under the control of the robot. As a result of the highly accurate orientation (implemented in the previous process step C-1) of the hinge mounting tool 6 with respect to the gripping tool 5 it is ensured here that the hinge holding faces 16 of the rear door 3 come to rest on the hinges 9 with a highly accurate orientation, while the orientation (implemented in section A-2) of the gripping tool with respect to the vehicle body 1 ensures that the rear door 3 is oriented in an optimal way with respect to the door opening 2.

Operation E (Attachment of the Rear Door 3 to the Hinges 9)

In the mounting position 29, which has been assumed again, of the gripping tool 5 in which the rear door 3 is positioned in an optimum way with respect to the door opening 2, the rear door 3 is then attached to the hinges 9 in the door opening 2. Screwdrivers (not shown in the figures), which are mounted, for example, on the gripping tool 6 and engage on the hinges 9 or on attachment screws for this operation, can be used for this purpose. Alternatively, additional screwdrivers which are attached to further robots or handling systems may be used.

After the vehicle door 3 has been mounted, the securing device 14 of the gripping tool 5 is released so that the door 3 hangs freely on the vehicle body 3. In this position, measurements for checking the joint dimensions, gap dimensions and depth dimensions in the areas 30, 31 are carried out (using the sensors 14). If deviations are detected here from the setpoint dimensions, defined information for subsequent operations is supplied to the operator of the system.

Movement Path Section F (Return Movement of the Gripping Tool 5):

When the rear door 3 has been attached in the correct position in the door opening 2, the securing device 14 of the gripping tool 5 is pivoted out of the engagement position in such a way that the gripping tool 5 can be moved back from the mounting position 29 into the return movement position 36 in a collision-free fashion under the control of the robot. The vehicle body 1 is distressed, lifted out and conveyed, and in parallel with this, the tools 5, 6 are equipped with a new door 3, hinges 9 and screws, and a new vehicle body 1 is fed into the working space 4.

For the purpose of data communication between the different system components (evaluation units 33, 45 of the sensor systems 18, 24 and the control systems of the robots 7, 8 in the control system 10), a TCP/IP interface is advantageously used in the present exemplary embodiment, said interface making a high data rate possible. Such a high data rate is necessary in order to be able to perform closed-loop control of the entire system (sensor systems/robots) with the large number of individual sensors 19, 25 using the interpolation cycle of the robots 7, 8 (typically 12 milliseconds) during the positioning phases A-2 and C-1 which are to be run through in a closed-loop controlled fashion. For closed-loop control problems less complex—i.e. when lower requirements are made of the accuracy and for longer closed-loop control times, the closed-loop control can also be carried out by means of a conventional serial interface.

In the previous description, the specific case of mounting a rear door 3 in a vehicle body 1 was described. Of course, the method can also be applied to the mounting of driver's doors in vehicle bodies 1, in which case, for reasons of better ease of access for the respective tools 5, 6, the rear door and driver's door are advantageously not positioned and mounted simultaneously, but rather sequentially.

Furthermore, in addition to the mounting of doors, the method can be transferred to the mounting of any other flaps (fuel tank flap, engine hood, tailgate etc.) which have to be mounted on the vehicle body 1 in a precisely positioned fashion. Finally, the method is not restricted to mounting situations on vehicle bodies but can basically be applied to any mounting problems in which a flap is to be mounted on a workpiece in a precisely positioned fashion using robot-guided tools 5, 6. “Robot-guided” tools are to be understood in the context of the present application in a quite general way as tools which are mounted on a multi-axle manipulator, in particular a six-axle industrial robot 7, 8.

As well as the previously described gap sensors, any other optical sensors may be used as sensors 19 for sensing the actual position of the flap 3 with respect to the reference area 11 on the workpiece 1. For example, CCD cameras which measure over an area can be used, by means of which sensors 19 (in combination with suitable image evaluation algorithms) it is possible to generate the spatial positions and the mutual offset of edges as well as spatial distances etc. as measured variables. The same applies to the sensors 25 which are used for the orientation of the hinge mounting system 6 with respect to the auxiliary face 42 on the gripping tool 5. Furthermore, any tactile and/or contact-free measurement systems can be used, with the selection of the suitable sensors depending greatly on the respective individual case.

In the exemplary embodiments in FIG. 5 in which the reference area on the gripping tool 5 is configured as a planar face 42 perpendicular to the longitudinal direction 44 of the vehicle and the sensors 25 are distance measuring sensors, the auxiliary face 42 permits positions to be measured and the hinge mounting tool 6 to be oriented only in the longitudinal direction of the vehicle; the positioning in the transverse direction of the vehicle is carried out in this case, as described above, in an open-loop controlled fashion. The reference area 26 may quite generally be any shaped area which permits spatial orientation of the hinge mounting system 6 with respect to the gripping tool 5 in all three spatial directions. In particular, the hinge mounting tool 6 may be oriented with respect to the hinge screw-on face 16 of the door 3.

Furthermore, the hinges 9 may be mounted in the door opening 2 of the vehicle body 1 in a manual fashion: in this case the process steps C-0 to C-2 for automatic preparation, positioning and mounting of the hinges 9 are dispensed with and instead replaced by a manual hinge mounting process.

In the exemplary embodiment in FIGS. 1 to 5, a (first) sensor system 18 is provided on the gripping tool 5, said sensor system 18 being used to position the gripping tool 5 with respect to the vehicle body 1, while a (second) sensor system 25, which is used to position the hinge mounting system 6 with respect to the gripping tool 5 is provided on the hinge mounting system 6. Instead of these doubled sensor system 18, 24, the positioning of the hinge mounting system 6 with respect to the gripping tool 5 can also be carried out using additional sensors on the gripping tool 5; in this case the auxiliary face 42 is not provided on the gripping tool 5 but rather on the hinge mounting system 26. In this way, it is possible to use just one single sensor system 24 which is attached to the gripping tool and contains both sensors 19 for orienting the gripping tool 5 with respect to the vehicle body and sensors 25 for orienting the hinge mounting system 6 with respect to the gripping tool 5.

Furthermore, the closed-loop control of the position of the gripping tool 5 with respect to the vehicle body does not need to be restricted to the positioning face A-2 but instead the gripping tool 5 can observe the vehicle body 1 using selected (additional) sensors during the entire mounting process. Owing to the high-speed algorithms for controlling positions, in such a case the vehicle body 1 does not need to be clamped in a fixed fashion during the positioning and mounting process but rather can be moved with respect to the robots 7, 8 (for example on an assembly line or some other suitable conveying equipment). This permits a high degree of flexibility of the method according to the invention, which method can thus be applied to very different application cases of the mounting a flap on fixed and moving workpieces.

1-9. (canceled)

10. A method for mounting a flap on a workpiece, the flap being positioned precisely with respect to a reference area on the workpiece using a gripping tool guided by a robot, the gripping tool including a securing device for holding the flap and a sensor system fixedly connected to the gripping tool, the sensor system including at least one sensor, the method including:
moving the gripping tool during a positioning phase from a proximity position independent of a workpiece position of the workpiece in a working space of the robot into a mounting position, the flap in the mounting position being held in the gripping tool and being oriented in a precisely positioned fashion with respect to the reference area of the workpiece, the flap being connected to the workpiece in the mounting position of the gripping tool,
the moving including running an iterative closed-loop control process, the closed-loop control process including:
generating an actual measured value of the at least one sensor;
comparing the actual measured value with a setpoint measured value generated during a setup phase,
calculating a movement vector of the gripping tool from a difference between the actual measured value and the setpoint measured value using a Jacobi matrix calculated during the setup phase; and
moving the gripping tool by an amount equal to the movement vector.

11. The method as recited in claim 10 wherein the iterative closed-loop control process is completed if either the difference between the setpoint measured value and actual measured value lies below a predetermined threshold value, or a reduction, brought about in successive iteration steps, in the difference lies below a predefined threshold.

12. The method as recited in claim 10 further comprising, following the closed loop control process,
moving the gripping tool into an avoidance position in a open-loop controlled fashion;
attaching attachment elements to the workpiece using a robot-controlled hinge mounting system;
moving the gripping tool back into the mounting position in an open-loop controlled fashion from the avoidance position;
attaching the flap held in the gripping tool to the attachment elements.

13. The method as recited in claim 12 wherein to attach the attachment elements to the workpiece the hinge mounting system is first moved under the control of a further robot into a further proximity position independent of the position of the workpiece in the working space of the further robot, the hinge mounting system then being moved in an iterative closed-loop control process into a hinge working position, the hinge mounting system in the hinge working position being oriented in a precisely positioned fashion with respect to the gripping tool, and a processing operation then being carried out under the control of the further robot to connect the attachment elements fed from the hinge mounting system to the workpiece.

14. The method as recited in claim 12 wherein the attachment elements are hinges screwed to the workpiece and to the flap.

15. The method as recited in claim 10 wherein a TCP/IP interface is used for communicating between an open-loop control system of the robot and an evaluation unit of the sensor system.

16. The method as recited in claim 10 wherein the flap is a vehicle door and the workpiece a vehicle body.

17. A device for mounting a flap on a workpiece comprising:
a gripping tool guided using a robot;
a sensor system fixedly connected to the gripping tool and including a metrically-non-calibrated sensor;
an open-loop control system for open-loop controlling the robot and the gripping tool; and
an evaluation unit for evaluating measured values of the sensor system.

18. The device as recited in claim 17 wherein the sensor is an optical gap measuring sensor.
